(19) United States
(12) Patent Application Publication
(10) Pub. No.: US 2011/0057158 A1
(43) Pub. Date: Mar. 10, 2011

(54) METHOD AND ARRANGEMENT FOR TRANSPORTING OF ELONGATED, BULKY PRODUCTS

(75) Inventors: Christoph Von Kessel, Kleinmachnow (DE); Mirko Hoermann, Werne (DE); Thomas Goldammer, Weimar (DE); Carl Freiherr Von Gablenz, Berlin (DE)

(73) Assignee: CL CARGOLIFTER GMBH & CO. KG A.A., Berlin (DE)

(21) Appl. No.: 12/677,968

(22) PCT Filed: Jul. 14, 2008
(86) PCT No.: PCT/EP2008/059170

§ 371 Date: Aug. 20, 2010

(30) Foreign Application Priority Data
Sep. 12, 2007 (DE) 10 2007 043 426.1

(51) Int. Cl. B66D 3/00; B64B 1/40

(52) U.S. Cl. 254/323; 254/266

(57) ABSTRACT

Elongated, bulky products are transported by means of a cable-guided lift body (1) connected to the load (15) by way of at least one mobile, controllable winch (13) via a hauling cable (18) and via a supporting cable (4; 7) and a rotatable load bearing unit (12). The bulky load (15) clamped in the load bearing unit (12) at the center of gravity can freely rotate in the wind during transport and maintain the horizontal position by means of a tilting joint (9) just above the center of gravity of the load bearing unit (12). The inside surfaces of the load bearing unit (12) are adjusted to the shape of the load (15) and fix the same. The load bearing unit (12) is connected to the lift body (1) via a rotatable joint (8) and hauling cables (18), preferably having three mobile, controllable winches (13), and via a further rotatable joint (8) and a supporting cable (7; 4). The method and the arrangement for transporting elongated, bulky products, utilizing a cable-guided lift body is suitable particularly for the transport of the wings of wind power systems across far distances, even with non-existent infrastructure, or such that is not suitable for conventional transport methods.

The invention relates to a method and an arrangement for the transportation of elongated, bulky goods, particularly blades for wind turbines, by means of a cable-guided lifting body.

The transportation of elongated, bulky goods by means of tractor-trailers is generally known. Such a method of transportation can be very time-consuming and expensive, particularly when the distances are very long and the infrastructure unsuitable.

The use of “lighter-than-air” vehicles in a variety of possible applications both in the civil and military sectors is also known.

It is therefore suggested to transport large and heavy goods by means of an airship or towed balloon, the load being accommodated on a lowerable platform in the case of airships, and in a load frame in the case of towed balloons, as in CL 75.

DE 102 10 540 A1 discloses a cable-guided lifting body, particularly for shifting loads, which lifting body is tied down via at least three cables, which are anchored on the ground and the free length of which is modifiable by means of dedicated, remote-controlled ground winches. The tackle of the balloon is directed toward a balloon node, which is connected via an intermediate cable to a crane node, from which the tying cables and a hook cable comprising a crane hook branch off.

For transporting heavy loads in areas of weak infrastructure and on grounds having low load-bearing capacity, DE 102 26 868 A1 discloses a load transporter comprising a track vehicle, which is connected to a “lighter-than-air” vehicle, the lifting force of which corresponds, at least in part, to the weight of the load. When used for loading and unloading, the lifting force of the aerostat is greater than the weight of the load and less than the vehicle with the load. The load transporter comprises a crane winch, a winch cable connected to the load node, and two intermediate cables, each of which is connected to a block and tackle.

The object underlying the invention is to suggest a method and an arrangement for the transportation of elongated, bulky goods over long distances even in the absence of infrastructure, or in the case of infrastructure that is unsuitable for conventional methods of transportation.

This object is achieved according to the invention by the features defined in Claims 1 and 2. Advantageous developments of the invention are defined in the dependent claims.

According to the invention, the lifting body is equipped with a device or a frame suspended thereunder, in which the cargo is clamped at the center of gravity. The lifting body is tied down and guided by means of controllable winches, which are mounted on at least one mobile unit, for example, on trucks. Depending on conditions, 2-3 trucks comprising actively controlled winches enable the maximum possible flexibility in order to dodge obstacles.

The flying altitude and course of the lifting body together with the load are determined by the movement of the mobile units and the change in the length of the tying cables. The lifting body can be guided arbitrarily in the horizontal and vertical directions, and the cargo can thus dodge obstacles and yet constantly remain horizontal and always rotate in the wind in order to offer the least resistance.

The transport system consists of several components. The actual spherical lifting body is a balloon or an aerostat that is made of a special membrane and used for receiving the lifting gas (hydrogen or helium). The load-bearing capacity is determined by the volume of the balloon and the lifting gas used. An increase in the load-bearing capacity is basically possible by the use of a larger balloon. The size of the lifting body used is chiefly determined by the load to be transported. The actual lifting body is enveloped by a net or any other suitable support, to the lower region of which the supporting cable is attached at the balloon nodal point. The net is equipped with additional devices, to which cables can be attached for securing the lifting body in order to secure the latter on the ground, for example, during a storm. The load-bearing unit, which is specially tailored to the load to be transported, is present at one end of the supporting cable. The supporting cable and the load-bearing unit are connected by means of a rotating joint so that the load to be transported can be oriented in the wind and held horizontally by means of a tilting joint on the load-bearing unit, and the area exposed to wind is thus reduced and a more secure transportation can be ensured. The load-bearing unit is specially adapted to the shape of the cargo. In order to prevent the load from slipping, it is secured to the load-bearing unit. Various methods such as anchoring the cargo with the aid of cables or securing it by means of bolts are suitable for this purpose depending on the load. Cushions tailored to the cargo prevent damage to the same. Connecting cables for the mobile winches are attached to the lower part of the load-bearing unit. Depending on the field and type of application, one to three mobile winch bases are required. As soon as more than one mobile winch base is required, the towing cables are connected to the load-bearing unit by means of a pivoted double or triple draft (swivels) in order to prevent the towing cables from getting entangled. The towing cables run on commercially available crane winches that are mounted on a mobile transport unit. In principle, different transport vehicles, particularly trucks, are suitable as mobile transport units. However, a rail-guided transport unit is also feasible.

The suggested method of the invention enables the transportation of elongated, bulky cargo over long distances, the transportation also including the pickup and lowering of the load. The reason for developing the system of the invention is the transportation of blades for wind turbines in mountainous regions, in which a normal transport via tractor-trailers is possible only very laboriously as a result of the extremely curvy routing and configuration of roads. However, the transport system is also suitable for a variety of other cargo, e.g., long pipes of large diameter. It makes sense to use the transport system of the invention particularly in the absence of infrastructure for conventional methods of transportation or in the case of infrastructure that is not suitable for the same. The invention also enables grounds having low load-bearing capacity to be better used for transportation.

The invention will be explained in more detail below with reference to a schematic exemplary embodiment.

In the associated drawings:

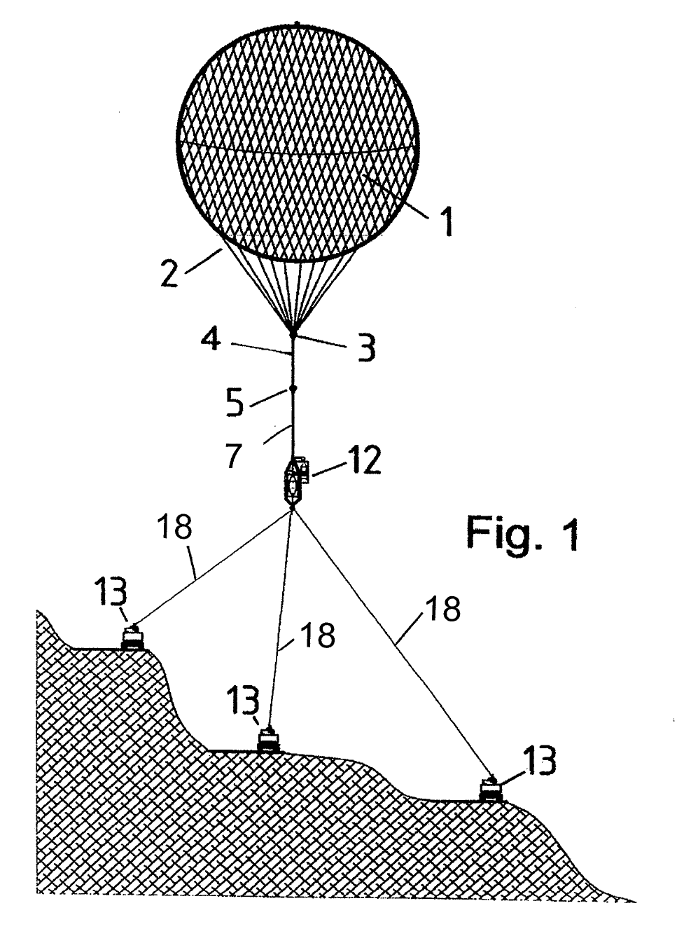

FIG. 1: shows a transport system in a staggered operation of the winch bases on winding roads in mountainous regions;

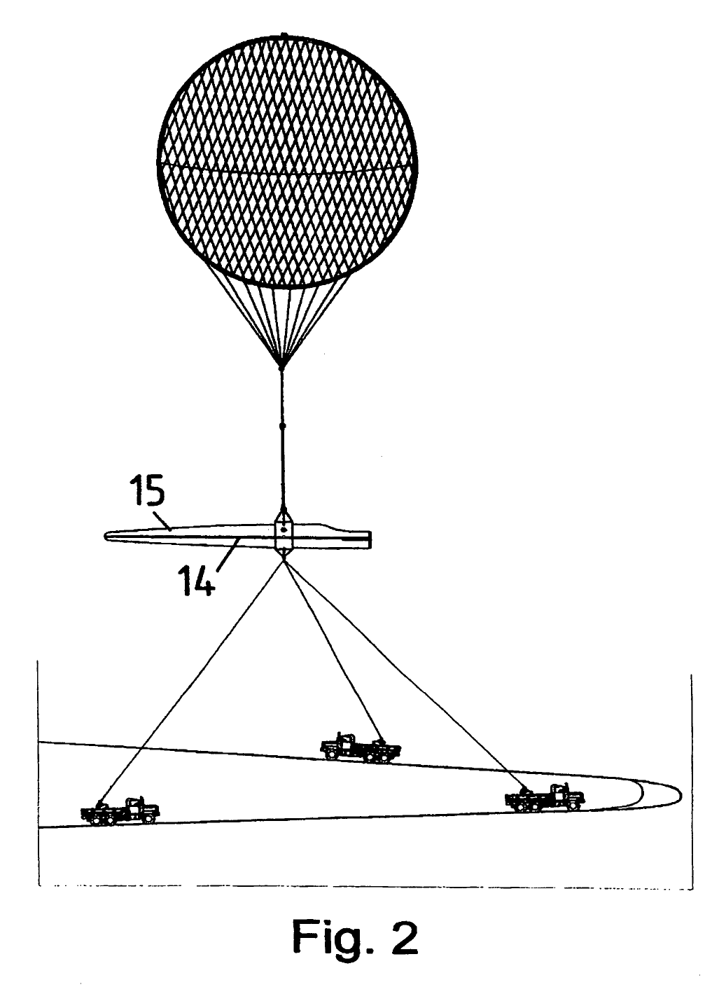

FIG. 2: shows a transport system when transporting a blade for wind turbines on curvy roads;

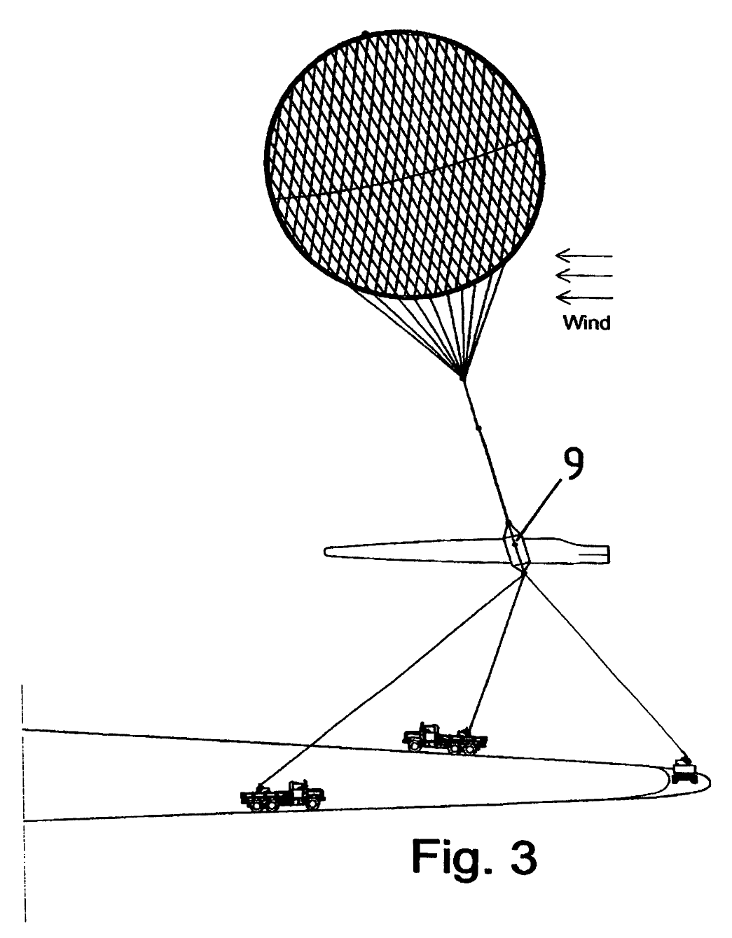

FIG. 3: shows a transport system with possible wind effects;

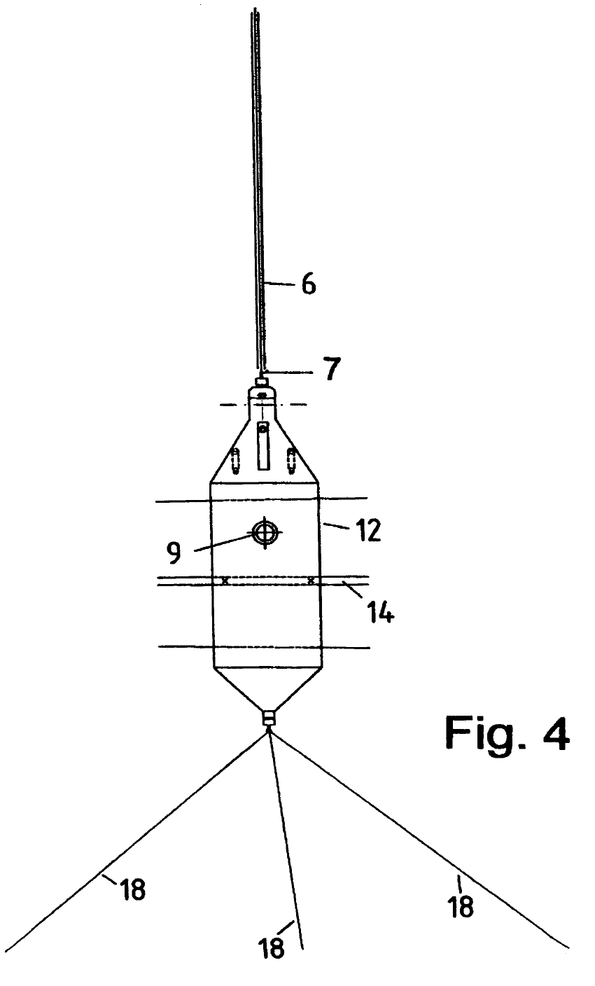

FIG. 4: shows a load-bearing unit comprising a clamped blade and rotating connections to the lifting body and the towing cables;

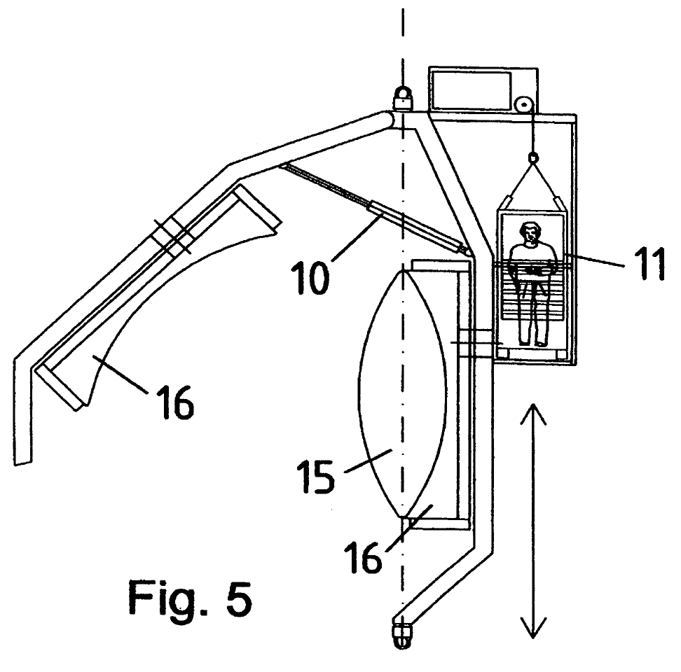

FIG. 5: shows the blade in an open load-bearing unit and during operation of a passenger hoist;

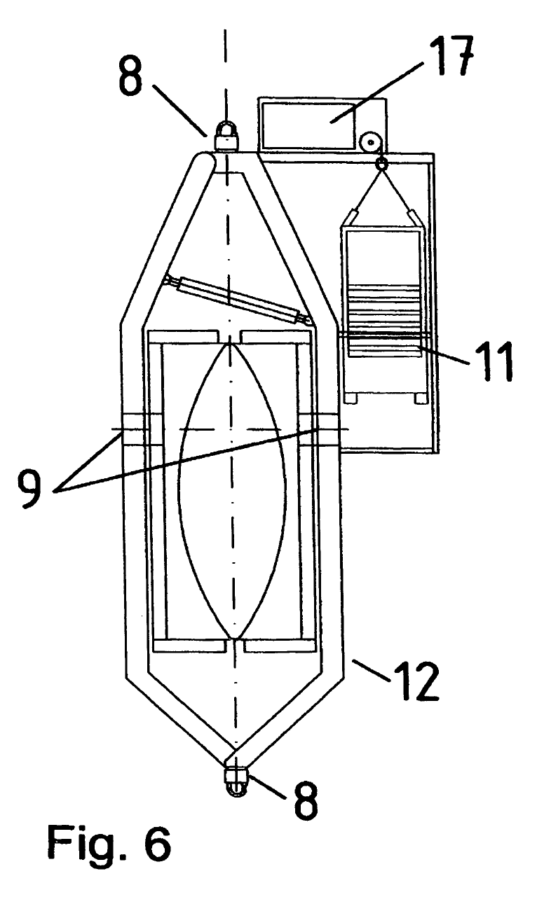

FIG. 6: shows the blade in a closed load-bearing unit and during operation of a passenger hoist;

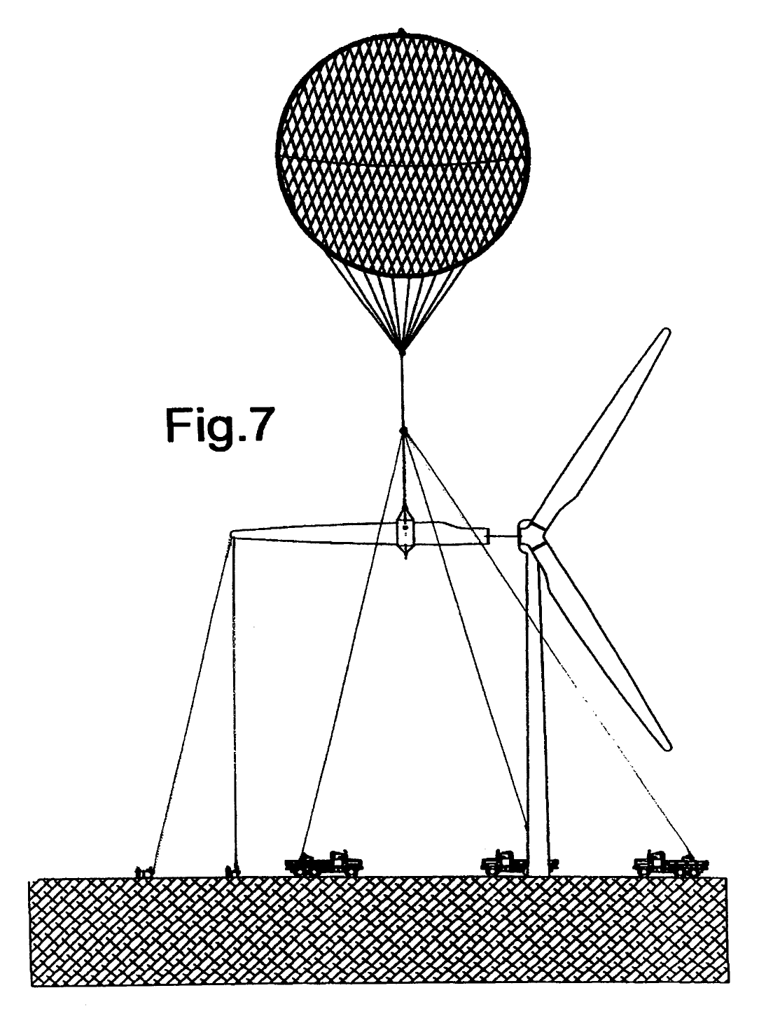

FIG. 7: shows the use of the invention as a balloon crane when mounting a blade on the generator with manual safety against wind effects.

The transport system shown in FIG. 1 in a staggered operation of the winch bases 13, mounted on trucks, on winding roads in mountainous regions uses a balloon 1 as the lifting body, the balloon having a balloon net 2, the lower ends of the balloon net 2 being combined in a balloon nodal point 3. The lifting body 1 can have any desired shape and can also be coupled to the balloon nodal point 3 by means of other known connections apart from the balloon net 2. The load-bearing unit 12 receiving elongated, bulky goods is connected to the balloon nodal point 3 by means of a lower supporting cable 7, a crane nodal point 4 [sic: 5] and an upper supporting cable 4, and is connected to the winches 13 on the mobile transport units by means of towing cables 18. The insertion of the crane nodal point 4 [sic: 5] and thus a division of the supporting cable into a lower supporting cable 7 and an upper supporting cable 4 partly decouples the movement of the load 15 in windy conditions, particularly during the use of the transport system as a crane, from the movement of the lifting body 1.

FIG. 2 shows the transportation of a blade for wind turbines as the cargo 15 on curvy roads with the aid of winch bases mounted on trucks, the blade 15 being secured by means of a constraint 14, e.g., a belt.

FIG. 3 shows the transport system with possible wind effects, the blade 15 being held independently in the horizontal position by the tilting joint 9 of the load-bearing unit 12.

FIG. 4 shows the load-bearing unit 12 comprising a clamped blade 15 secured by a belt in the form of a constraint 14, [and] rotating connections to the lifting body 1 and the towing cables 18. For this purpose, the load-bearing unit 12 comprises, as shown in FIG. 6 in more detail, swivels 8 for the lower supporting cable 7 and the towing cables 18. Apart from the lower supporting cable 7, crane cables 6 for crane operations are disposed on the crane nodal point 5.

FIGS. 5 and 6 show blades 15 in an open and closed load-bearing unit 12 together with a cabin during operation of a passenger hoist 11. The load-bearing unit 12 represents a stable construction in a suitable design, e.g., in the form of a frame made of two parts, which are pivoted at one end and can be opened by means of a hydraulic system 10 and closed securely after the insertion of the cargo 15. The two opposing inner surfaces comprise shell-shaped cushions 16 shaped as the bisected cross-section of the cargo 15, the blade 15 in the exemplary embodiment. If long tubes are to be transported, the cushions 16 are provided with a semicircular cross-section. The load-bearing unit 12 can be formed such that a passenger hoist 11 comprising a winch 17 for a cabin is disposed on that part of the load-bearing unit that stands vertically during the opening process. In FIG. 6, swivels 8 are each disposed on the upper and lower sides of the suspended load-bearing unit 12, and tilting joints 9 are disposed just above the center of gravity on opposite sides of the load-bearing unit.

FIG. 7 shows the use of the invention as a balloon crane when mounting a blade of a wind turbine on the generator with manual safety against wind effects. For this purpose, the three crane cables 6 from the crane nodal point 5 are connected to the winches 13 on the mobile transport units, and the required position of the balloon 1 is assumed by means of a suitable change in the lengths of the individual winches 13. The manual safety against wind effects is provided by means of two cables attached to the blade end by means of small winches.

The transport process is as follows: The goods to be transported are brought into position and secured at the unloading point. The lifting body together with the load-bearing unit is brought into position above the cargo. The mobile winch bases are positioned around the cargo. The cargo is clamped in the load-bearing unit and secured, if necessary. The cargo is lifted by the lifting body and the unrolling of the guide cables from the winches or a change in location of the mobile winch bases. The lifting body together with the cargo is navigated by means of the staggered movement of the transport vehicles and a change in the length of the guide cables. The lowering is carried out in reverse order or the cargo is directly brought into the mounting position (e.g., generator on wind turbines) and decoupled from the balloon movement by connecting the cables attached to the upper crane nodal point to the winches located on the ground, and positioned precisely for being screwed. This design thus offers the option of a simultaneous use for crane operations.

### LIST OF REFERENCE SIGNS AND TERMS USED

1 Balloon

2 Balloon net

3 Balloon nodal point

4 Upper supporting cable

5 Crane nodal point

6 Crane cables

7 Lower supporting cable

8 Swivels

9 Tilting joint

10 Hydraulic system

11 Passenger hoist

12 Load-bearing unit

13 Winch on mobile transport unit

14 Constraint of 15

15 Cargo

16 Cushions

17 Winch for passenger hoist

18 Towing cables

1. A transportation method comprising:
clamping an elongated, bulky load in a rotating and tilting load-bearing unit;
transporting the elongated, bulky load with a cable-guided lifting body with the aid of the load-bearing unit
wherein the elongated, bulky load, which is clamped in the load-bearing unit at a center of gravity, rotates independently of the load-bearing unit and maintains a horizontal position,
wherein the load-bearing unit is connected to at least one mobile controllable winch with at least one towing cable for the at least one mobile controllable winch, and
wherein the load-bearing unit is connected to the lifting body with a supporting cable.

2. An apparatus, comprising:
a cable-guided lifting body to transport an elongated, bulky load;
a supporting cable connected to the lifting body;
an opening load-bearing unit,
which is equipped with a rotating and tilting joint,
which is adapted to a shape of the load, and
which holds the load in position, and
at least one mobile controllable winch connected to the opening load-bearing unit by at least one towing cable;
wherein the load-bearing unit is connected by an additional rotating joint to the supporting cable.

3. The apparatus of claim 2, wherein the lifting body is a balloon or an aerostat.

4. The apparatus of claim 2, wherein the lifting body comprises a support, to the lower end of which the supporting cable is attached.

5. The apparatus of claim 4, wherein the lifting body comprises a balloon having a balloon net,
wherein the balloon net forms a balloon nodal point, and
wherein the balloon nodal point is connected to an upper supporting cable.

6. The apparatus of claim 2, wherein the at least one mobile controllable winch is a controllable winch disposed on a truck.

7. The apparatus of claim 2, wherein the towing cable of the at least one mobile controllable winch is connected through a pivoted swivel to the load-bearing unit.

8. The apparatus of claim 2, further comprising a remote control configured to open the load-bearing unit.

9. The apparatus of claim 2, further comprising two half shells, which comprise cushions and which are adapted to a cross-section of the load are disposed in the load-bearing unit, and
wherein the two half shells pivot a tilting joint which is disposed above a center of gravity.

10. The apparatus of claim 2, further comprising:
an upper supporting cable extending from the balloon nodal point to a crane nodal point, and
a lower supporting cable extending from the crane nodal point to an upper swivel of the load-bearing unit.

11. The apparatus of claim 10, further comprising a plurality of crane cables detachably attached to the lower swivel during transportation of the elongated, bulky load and to the crane nodal point during operation of the crane.

12. The apparatus of claim 2, further comprising a base having a winch and a guidance for a cabin of a passenger hoist which is disposed at a pivot of movable halves of the load-bearing unit on a side of the load-bearing unit that does not open.
